(19) United States
(12) Patent Application Publication
(10) Pub. No.: US 2023/0212818 A1
(43) Pub. Date: Jul. 6, 2023

(54) SYSTEM AND METHOD FOR PRODUCING A COMPOSITION BASED ON PLANT MUCILAGE

(71) Applicant: Hausman Properties, LLC, Houston, TX (US)

(72) Inventor: Brian Hausman, Houston, TX (US)

(21) Appl. No.: 18/182,333

(22) Filed: Mar. 11, 2023

Related U.S. Application Data
(63) Continuation of application No. 17/844,521, filed on Jun. 20, 2022.
(60) Provisional application No. 63/212,648, filed on Jun. 19, 2021.

(51) Int. Cl. D06N 3/00; C08L 75/04; C08L 99/00; D06N 3/14; D06N 3/18

(52) U.S. Cl. CPC D06N 3/0061; C08L 75/04; C08L 99/00; D06N 3/14; D06N 3/0077; D06N 3/0097; D06N 3/0036; D06N 3/183; D06N 2203/024; D06N 2211/28

(57) ABSTRACT

The disclosure provides methods for producing plant-based compositions. The plant-based composition comprises a mixture comprising mucilage derived from Opuntia ficus-indica and polyurethane, wherein the mixture comprises at least about 10 wt % of mucilage. The plant-based composition further comprises a textile support coupled to the mixture, wherein at least a portion of the textile support is saturated by the mixture.

### CROSS-REFERENCE TO RELATED APPLICATION

The present application claims the benefit of U.S. Non-Provisional Application No. 17/844,521 filed on Jun. 20, 2022, which claims the benefit of U.S. Provisional Application No. 63/212,648 filed on Jun. 19, 2021, which are incorporated herein by reference in their entireties for all purposes.

### TECHNICAL FIELD OF THE INVENTION

The present disclosure relates generally to compositions based on plant mucilage and, more particularly, to a system and method for producing a composition for artificial leather based on plant mucilage.

### BACKGROUND

The leather manufacturing industry is associated with numerous negative effects, such as creating waste runoff containing toxic and hazardous chemicals that are harmful to the environment and unethical sourcing of the animals used for production. Turning animal hides into leather requires massive amounts of energy and dangerous chemicals, including mineral salts, formaldehyde, coal-tar derivatives, and various oils, dyes, and finishes, some of them cyanide-based.

Raising the animals whose hide eventually becomes leather requires vast quantities of water and wide tracts of pastureland, which must be cleared of trees. Runoff from feedlots and farms also creates a major source of water pollution. Leather has the greatest impact on eutrophication, a serious ecological problem in which runoff waste creates an overgrowth of plant life in water systems, suffocating animals by depleting oxygen levels in the water and is the leading cause of hypoxic zones, also known as “dead zones.” Further, large amounts of fossil fuels are consumed in livestock production as well, and cow-derived leather has almost three times the negative environmental impact as its synthetic counterparts, including polyurethane (PU) leather.

There is a need for improved leather compositions and manufacturing processes.

### BRIEF DESCRIPTION OF THE DRAWINGS

These drawings illustrate certain aspects of some of the embodiments of the present disclosure and should not be used to limit or define the claims.

FIG. 1 illustrates an example of a plant-based composition, in accordance with certain embodiments of the present disclosure.

FIG. 2 illustrates an example method of producing the plant-based composition of FIG. 1, in accordance with certain embodiments of the present disclosure.

FIG. 3A illustrates an example of an article of manufacture comprising the plant-based composition of FIG. 1, in accordance with certain embodiments of the present disclosure.

FIG. 3B illustrates an example of an article of manufacture comprising the plant-based composition of FIG. 1, in accordance with certain embodiments of the present disclosure.

While embodiments of this disclosure have been depicted, such embodiments do not imply a limitation on the disclosure, and no such limitation should be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

The present disclosure provides for systems and methods for producing a composition for artificial leather based on plant mucilage. In one or more embodiments, the present disclosure provides compositions of and methods of manufacturing artificial or synthetic leather from polyurethane and the mucilage derived from plants. In embodiments, the plants are classified as belonging to the Cactaceae family. In other embodiments, the mucilage may be derived from plants belonging to any suitable classification family. In embodiments, the mucilage may be derived from Opuntia ficus-indica and/or similar plants. In other embodiments, the mucilage may be extracted from other high-mucilage containing plants, such as flaxseeds.

The mucilage and/or other plant material may be combined into a mixture of a polymer to be coupled with a textile for support. Without limitations, such textiles may include polyester, cotton, blends thereof, plastics, polymers such as polyvinyl chloride, polyurethane, and/or polypropylene, and any combinations thereof. Any suitable material and polymer may be used as the textile support and/or as the polymer. A plasticizer may be included in the compositions to provide flexible attributes to the composition. In embodiments, a volume of specimens of plants, such as Opuntia ficus-indica or related plants, may be harvested or collected. The volume of specimens may be processed to produce the derived mucilage from the volume of specimens. Any suitable manufacturing process may be used for harvesting and/or processing the volume of specimens, such as cleaving, shredding, using a thresher and/or hopper, using a cutter, using an extractor, pressing, rolling, crushing, grinding, filtering, cleaning, sorting, heating, drying, and any combinations thereof.

In embodiments, the mucilage and/or plant material may be combined with the textile support. The mucilage may be directly applied to the textile support and/or indirectly applied through applying polyvinyl chloride and/or polyurethane to the textile support, wherein the mucilage may be disposed within and mixed with the polyvinyl chloride and/or polyurethane. Pressure may be applied throughout the previous steps to the combination of the textile support, mucilage, polyvinyl chloride, and/or polyurethane. The resulting composition may undergo a heating process. A secondary process may be applied to alter the texture and physical appearance of the produced composition. Such processes may include pressing, rolling, etching, and the like to the surface of the composition. In embodiments, the composition may undergo a process to improve the porosity and breathability of the composition. A wax and/or dye may be applied to the composition for treatment. Alternatively, the wax and/or dye may be applied instead of the polyvinyl chloride and/or polyurethane. In embodiments, any suitable additives may be included in the composition.

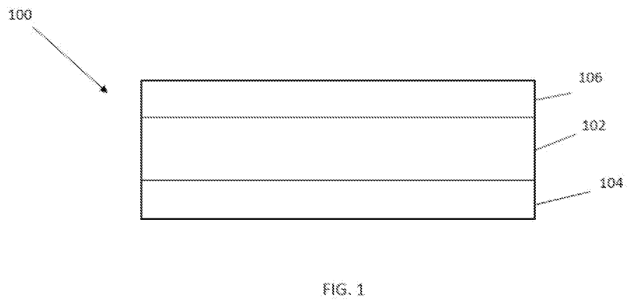

FIG. 1 illustrates a cross-section of an example plant-based composition 100. The plant-based composition 100 comprises a primary layer 102, a textile support 104, and a surface layer 106. The primary layer 102 may be disposed between the textile support 104 and the surface layer 106. In embodiments, the primary layer 102 may be bonded to both the textile support 104 and the surface layer 106. The primary layer 102 may comprise a mixture of a polymer and the mucilage of a suitable plant. The polymer may be any suitable polymer used in the manufacture of synthetic leathers. In embodiments, the polymer may be polyurethane (“PU”), polyvinyl chloride (“PVC”), polypropylene, textile-polymer composite microfibers, silicone, and any combination thereof. In embodiments, the polymer may be a biopolymer derived from living organisms. The polymer may be bio-based, wherein the polymer may be prepared by reacting natural oil polyols (NOP) with diisocyanates. The mucilage may be derived from one or more plants belonging to the Cactaceae family, such as Opuntia ficus-indica, or related plants. In embodiments, the mucilage may be produced as a powder of dehydrated Opuntia ficus-indica plants or as a liquid extract from Opuntia ficus-indica plants prior to addition to the mixture of the primary layer 102. Mucilage is a polar glycoprotein and exopolysaccharide. Mucilage may be a polysaccharide substance extracted as a viscous solution from plant roots, seeds, stems, or a combination thereof. For example, a plurality of cladodes of the Opuntia ficus-indica plant may store mucilage. In embodiments, a “cladode” may be an oblong, oval, spatulate-shaped stem of the plant. Mucilage may be produced from one or more Opuntia ficus-indica and mixed with a suitable polymer to produce the primary layer 102.

In one or more embodiments, the mixture of the primary layer 102 may further comprise any suitable additives, such as a plasticizer, a stabilizer, a surfactant, a blowing agent, a riser/rising agent, one or more pigments. The primary layer 102 may comprise any suitable weight percentage of PU. Without limitations, the primary layer 102 may comprise at least about 10 wt % of PU, 20 wt % of PU, 30 wt % of PU, 40 wt % of PU, 50 wt % of PU, 60 wt % of PU, 70 wt % of PU, 80 wt % of PU, or about 90 wt % of PU. The primary layer 102 may comprise any suitable weight percentage of mucilage derived from Opuntia ficus-indica. Without limitations, the primary layer 102 may comprise at least about 10 wt % of mucilage, 20 wt % of mucilage, 30 wt % of mucilage, 40 wt % of mucilage, 50 wt % of mucilage, 60 wt % of mucilage, 70 wt % of mucilage, 80 wt % of mucilage, or about 90 wt % of mucilage.

As illustrated, the textile support 104 may be disposed underneath the primary layer 102. In embodiments, the textile support 104 may be coupled to the primary layer 102 through any suitable means. For example, the mixture of the primary layer 102 may be applied directly onto the textile support 104 as a liquid, wherein the combination of the mixture and textile support 104 may be heated to cure the mixture and bond particles of the mixture to at least a portion of the textile support 104. In this example, at least a portion of the textile support 104 is saturated by the mixture of the primary layer 102. Without limitations, the textile support 104 may comprise cotton, polyester, blends thereof, or a combination thereof. The textile support 104 may have a rough and/or porous surface to facilitate bonding with the primary layer 102.

The surface layer 106 may be disposed on top of the primary layer 102. The surface layer 106 may be coupled to the primary layer 102 through any suitable means, such as through curing through a heating process. In embodiments, the surface layer 106 may be a coating applied to the primary layer 102. In other embodiments, the surface layer 106 may be a composition similar to the primary layer 102 (i.e., comprising mucilage and a polymer). The surface layer 106 may comprise a textured pattern for the plant-based composition 100. For example, once the surface layer 106 is disposed on the primary layer 102, the plant-based composition 100 may pass through textured rollers to produce a textured pattern on the surface layer 106.

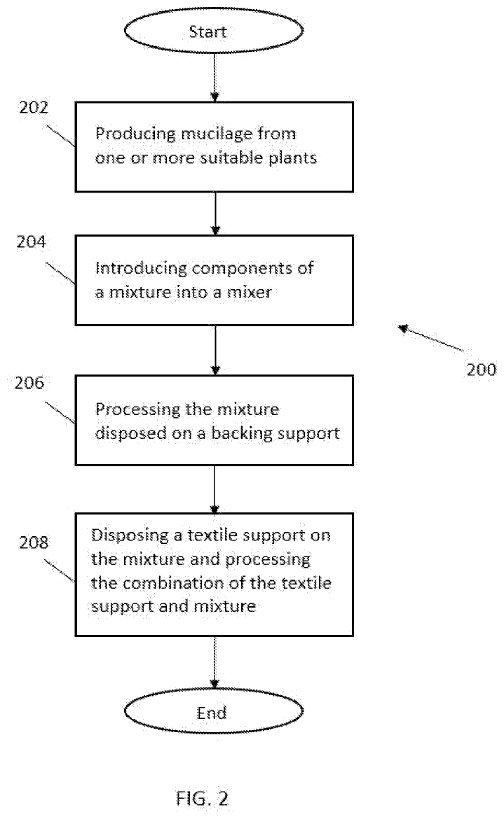

FIG. 2 illustrates an illustrates an example method 200 of producing the plant-based composition 100 (referring to FIG. 1). Method 200 may employ any suitable wet and/or dry manufacturing processes to produce an article of manufacture of artificial leather comprising mucilage. The method 200 may begin at step 202, where a user may produce mucilage from one or more suitable plants. For example, a suitable plant may be the Opuntia ficus-indica. The mucilage may be produced using any suitable method, such as liquid extraction or through dehydrating and pulverizing one or more plants into a powder. In certain embodiments, a liquid extract of mucilage may be produced from one or more Opuntia ficus-indica plants. In other embodiments, the mucilage may be produced in the form of a power of dehydrated, ground cladodes on one or more Opuntia ficus-indica plants. For example, step 202 may comprise of receiving a plurality of cladodes of one or more Opuntia ficus-indica. The plurality of cladodes may undergo a cleaning process. Once cleaned, the method 200 may continue with removing one or more spines extending from each one of the plurality of cladodes. Any suitable method may be used to remove the one or more spines from each cladode. A user may then reduce the received, processed plurality of cladodes into fragmented pieces. In embodiments, any suitable processes and machinery may be used to reduce the cladodes. Without limitations, such processes and machinery may include cleaving, shredding, using a thresher and/or hopper, using a cutter, using an extractor, pressing, rolling, crushing, grinding, and any combination thereof. The fragmented pieces of cladodes may then undergo a heat treatment. Step 202 may further comprise of applying heat to the fragmented pieces to facilitate dehydration of the fragmented pieces. For example, the fragmented pieces of cladodes may be left out in the sun, in a greenroom, introduced into a heating element (for example, an industrial oven), and the like so as to remove the moisture present within the fragmented pieces of cladodes. After being heat-treated, the fragmented pieces of cladodes may undergo grinding to produce a powder.

At step 204, the mucilage and a volume of polymer may be introduced into a mixer. In embodiments, the mucilage may be introduced as a liquid extract, as a powder, or as a combination thereof. A base fluid, such as water, may be added into the mixer. One or more additives may be introduced into the mixer during step 204. Without limitations, a plasticizer, a stabilizer, a surfactant, a blowing agent, a rising agent, one or more pigments, and any combination thereof may be introduced into the mixer. The mixer may be operable to receive one or more components and actuate to produce a mixture. The mixer may be actuated to stir the components for a predetermined period of time to produce a homogenous mixture. Once the mixture is produced, the mixture may be disposed onto a backing support for further processing.

At step 206, the mixture may be discharged onto a backing support. In embodiments, the backing support may have a non-stick surface and may be operable to support the mixture as the mixture cures. For example, the backing support may be a paper or textile covered in silicon, wherein the silicon prevents the discharged mixture disposed thereon to bond with the backing support. Further during method 200, the cured mixture may be separated from the backing support. The discharged mixture on the backing support may pass through one or more rollers to evenly distribute the mixture and to produce a uniform thickness. The discharged mixture on the backing support may undergo a heat-treatment to solidify and/or cure as the primary layer 102 (referring to FIG. 1). In one or more embodiments, a subsequent layer of mixture may be discharged on the solidified mixture and may undergo similar treatments. For example, the subsequent layer may pass through one or more rollers and may undergo a heat-treatment. In embodiments, the subsequent layer may comprise a rising agent.

At step 208, the textile support 104 (referring to FIG. 1) may be disposed on the mixture to provide strength and support to the mixture. An adhesive may be applied to the mixture, and the textile support 104 may be coupled to the mixture through the applied adhesive. The combination of the textile support 104 and mixture may pass through an oven, wherein the increase in heat may bond the textile support 104 with the mixture. A user may detach the combined textile support 104 and mixture from the backing support for further operations. The combined textile support 104 and mixture may then be passed through a set of textured rollers to produce a pattern on a surface of the mixture. In embodiments, a resin may be applied to the surface of the mixture before and/or after passing through the set of textured rollers. In embodiments, heat may be applied while the combined textile support 104 and mixture passes through the set of textured rollers. The method 200 may then end, wherein the combined textile support 104 and mixture may be used to manufacture a suitable article of manufacture.

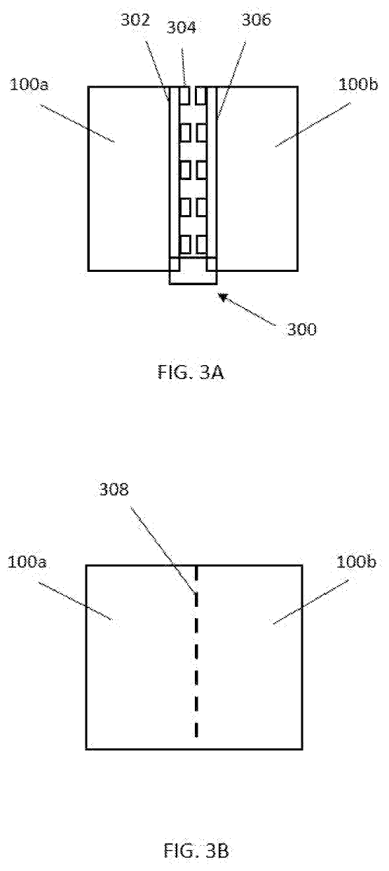

FIGS. 3A and 3B illustrate examples of an article of manufacture comprising the plant-based composition 100 of FIG. 1. The article of manufacture may comprise any suitable size, height, shape, and any combinations thereof. Further, the article of manufacture may comprise any suitable materials, such as metals, nonmetals, polymers, composites, and any combinations thereof. In an example, articles of manufacture may include clothing, clothing accessories, footwear, purses, handbags, furniture, upholstery, and the like. In embodiments wherein the article of manufacture is utilized by a user, the article of manufacture may comprise an opening configured to receive an appendage of the user (i.e., a hand or a foot). As illustrated, the article of manufacture may comprise a first plant-based composition 100a and a second plant based composition 100b. Both the first plant-based composition 100a and the second plant-based composition 100b may be produced by method 200 (referring to FIG. 1) or through any other suitable method. In embodiments, each one of the first plant-based composition 100a and the second plant-based composition 100b may comprise any suitable size, height, shape, and any combinations thereof. Without limitations, the first plant-based composition 100a and/or the second plant-based composition 100b may have a thickness less than about 1 mm, 2 mm, 3 mm, 4 mm, or about 5 mm. In further embodiments, the surface layer 106 (referring to FIG. 1) of the first plant-based composition 100a and/or the second plant-based composition 100b may have a thickness less than about 25 μm, 50 μm, 100 μm, or about 500 μm.

As illustrated in both FIGS. 3A and 3B, the first plant-based composition 100a may be coupled to the second plant-based composition 100b. Without limitations, the first plant-based composition 100a may be coupled to the second plant-based composition 100b through any suitable method, including through the usage of fasteners, adhesives, interlocking components, interference fit, and any combination thereof. As shown in FIG. 3A, the article of manufacture may further comprise a zipper 300 configured to selectively couple the first plant-based composition 100a to the second plant-based composition 100b. The zipper 300 may comprise a first track 302 of teeth 304 disposed at a side of the first plant-based composition 100a and a second track 306 of teeth 304 disposed at a side of the second plant-based composition 100b. In embodiments, the zipper 300 may be actuated to translate along each of the first track 302 and the second track 306 to couple or un-couple the first plant-based composition 100a to the second plant-based composition 100b.

FIG. 3B illustrates the first plant-based composition 100a coupled to the second plant-based composition 100b through a threading 308. For example, the first plant-based composition 100a and the second plant-based composition 100b may be sewn together via threading 308. In embodiments, any suitable stitch pattern may be used for threading 308. Further, any suitable thread material may be used for threading 308. Without limitations, the stitch pattern of the threading 308 may be a half inch selvage seam, top stitch, french seam, welt and boxing, zipper boxing, European diamond stitch, cross stitching, hexagonal stitching, and any combination thereof.

An embodiment of the present disclosure is a plant-based composition, comprising: a mixture comprising mucilage derived from Opuntia ficus-indica and polyurethane, wherein the mixture comprises at least about 50 wt % of polyurethane; and a textile support coupled to the mixture, wherein at least a portion of the textile support is saturated by the mixture.

In one or more embodiments described in the preceding paragraph, wherein the mixture further comprises a plasticizer. In one or more embodiments described above, wherein the textile support comprises polyester, cotton, or a combination thereof. In one or more embodiments described above, further comprising a surface layer disposed on top of the mixture.

Another embodiment of the present disclosure is a method of producing a plant-based composition, comprising: introducing mucilage of Opuntia ficus-indica into a mixer; introducing a volume of polyurethane into the mixer; actuating the mixer to produce a mixture comprising the mucilage and polyurethane; applying the mixture onto a backing support; applying heat to the mixture; disposing a textile support onto the mixture; heating the textile support and the mixture to bond the textile support to the mixture; and passing the mixture and the textile support through a set of textured rollers to produce a pattern on a surface of the mixture.

In one or more embodiments described in the preceding paragraph, wherein the mucilage is in the form of a powder of dehydrated Opuntia ficus-indica. In one or more embodiments described above, wherein the mucilage is in the form of a liquid extract. In one or more embodiments described above, further comprising introducing a volume of plasticizer and a volume of stabilizer into the mixer. In one or more embodiments described above, further comprising removing the mixture and the textile support from the backing support. In one or more embodiments described above, receiving a plurality of cladodes of one or more Opuntia ficus-indica; reducing the plurality of cladodes into fragmented pieces; applying heat to the fragmented pieces to facilitate dehydration of the fragmented pieces; and grinding the dehydrated fragmented pieces into a powder. In one or more embodiments described above, cleaning the plurality of cladodes; and removing one or more spines extending from each one of the plurality of cladodes. In one or more embodiments described above, an article of manufacture comprises a first plant-based composition prepared by the method of one or more previous embodiments; a second plant-based composition prepared by the method of one or more previous embodiments; and threading configured to couple the first plant-based composition to the second plant-based composition. In one or more embodiments described above, wherein at least one of the first plant-based composition and the second plant-based composition has a thickness less than about 1.4 mm. In one or more embodiments described above, wherein each of the first plant-based composition and the second plant-based composition comprises a surface layer. In one or more embodiments described above, wherein the surface layer is less than about 50 μm. In one or more embodiments described above, wherein the first plant-based composition and the second plant-based composition form an opening configured to receive an appendage of a user. In one or more embodiments described above, an article of manufacture comprises a first plant-based composition prepared by the method of one or more previous embodiments; a second plant-based composition prepared by the method of one or more previous embodiments; and a zipper configured to couple the first plant-based composition to the second plant-based composition, the zipper comprising a first track of teeth and a second track of teeth, the first track of teeth coupled to a side of the first plant-based composition, and the second track of teeth coupled to a side of the second plant-based composition.

A further embodiment of the present disclosure is a plant-based composition, comprising: a mixture comprising mucilage derived from Opuntia ficus-indica and polyurethane, wherein the mucilage is prepared by a process comprising the steps of: reducing a plurality of cladodes into fragmented pieces; applying heat to the fragmented pieces to facilitate dehydration of the fragmented pieces; and grinding the dehydrated fragmented pieces into a powder; a textile support coupled to the mixture; and a surface layer disposed on top of the mixture, the mixture disposed between the surface layer and the textile support. In an aforementioned embodiment, wherein the mixture comprises at least about 50 wt % of polyurethane.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A plant-based composition, comprising:
a mixture comprising mucilage derived from Opuntia ficus-indica and polyurethane, wherein the mixture comprises at least about 10 wt % of mucilage; and
a textile support coupled to the mixture, wherein at least a portion of the textile support is saturated by the mixture.

2. The plant-based composition of claim 1, wherein the mixture further comprises a plasticizer.

3. The plant-based composition of claim 1, wherein the textile support comprises polyester, cotton, or a combination thereof.

4. The plant-based composition of claim 1, further comprising a surface layer disposed on top of the mixture.

5. The plant-based composition of claim 4, wherein the surface layer has a thickness less than about 50 μm, wherein the plant-based composition has a thickness less than about 1.4 mm.

6. The plant-based composition of claim 1, wherein the plant-based composition has a thickness less than about 1.4 mm.

7. The plant-based composition of claim 1, wherein the mixture comprises at least about 10 wt % of polyurethane.

8. A method of producing a plant-based composition, comprising:
generating a mixture comprising mucilage of Opuntia ficus-indica and a volume of polyurethane;
applying the mixture onto a backing support;
applying heat to the mixture;
disposing a textile support onto the mixture;
heating the textile support and the mixture to bond the textile support to the mixture;
generating a pattern on a surface of the mixture; and
removing the mixture and the textile support from the backing support.

9. The method of claim 8, wherein the mucilage is in the form of a powder of dehydrated Opuntia ficus-indica.

10. The method of claim 8, wherein the mucilage is in the form of a liquid extract.

11. The method of claim 8, further comprising introducing a volume of plasticizer and a volume of stabilizer into the mixer.

12. The method of claim 8, further comprising:
reducing a plurality of cladodes of one or more Opuntia ficus-indica into fragmented pieces;
applying heat to the fragmented pieces to facilitate dehydration of the fragmented pieces; and
grinding the dehydrated fragmented pieces into a powder.

13. The method of claim 12, further comprising:
cleaning the plurality of cladodes; and
removing one or more spines extending from each one of the plurality of cladodes.

14. An article of manufacture, comprising:
a first plant-based composition prepared by the method of claim 8;
a second plant-based composition prepared by the method of claim 8; and
threading configured to couple the first plant-based composition to the second plant-based composition.

15. The article of manufacture of claim 14, wherein at least one of the first plant-based composition and the second plant-based composition has a thickness less than about 1.4 mm.

16. The article of manufacture of claim 14, wherein each of the first plant-based composition and the second plant-based composition comprises a surface layer.

17. The article of manufacture of claim 16, wherein the surface layer is less than about 50 μm.

18. The article of manufacture of claim 14, wherein the first plant-based composition and the second plant-based composition form an opening configured to receive an appendage of a user.

19. An article of manufacture, comprising:
a first plant-based composition prepared by the method of claim 8;
a second plant-based composition prepared by the method of claim 8; and
a zipper configured to couple the first plant-based composition to the second plant-based composition, the zipper comprising a first track of teeth and a second track of teeth, the first track of teeth coupled to a side of the first plant-based composition, and the second track of teeth coupled to a side of the second plant-based composition.
